(19) United States
(12) Patent Application Publication
(10) Pub. No.: US 2005/0236098 A1
(43) Pub. Date: Oct. 27, 2005

(54) Engineered resistive heated complex shape molded composite

(76) Inventor: Richard Blackmore, Houston, TX (US)

Correspondence Address: LAW OFFICE OF DAVID MCEWING, P.O. BOX 231324, HOUSTON, TX, 77023, US

(21) Appl. No.: 10/831,933

(22) Filed: Apr. 26, 2004

(51) Int. Cl. B32B 31/00

(52) U.S. Cl. 156/272.2

(57) ABSTRACT

The apparatus and method for manufacturing composite materials utilizing in situ resistive heating of thermal responsive materials such as thermosetting and thermoplastic resin composites by the strategic placement of non metallic conductive fibers. The electrically conductive fibers, which are energized to provide resistive heating, become part of the laminate.

### BACKGROUND OF INVENTION

1. Field of the Invention

The present invention relates to a method to manufacture large molded composite materials of complex shapes. The invention also relates to the produced composite materials.

2. Background of the Invention

Composite materials have become widely used in many differing applications. High cost advanced composite materials continue to be used in selected and specialized applications, for example in aerospace applications. Lower cost engineered materials continue to grow in application but face continued problems of extended and expensive manufacturing time. There are also problems with manufacturing structurally sound large composite. For example, there are continued problems of material de-lamination.

The applicant herein has previously developed methods and apparatus for forming resin molded composite containing electrically conductive fibers, for resistive heating, within the mold or the material being molded. These inventions are subject of U.S. Pat. Nos. 5,591,291, 5,648,137, 5,656,231, and 6,146,576. Included within the specifications of these patents is a disclosure of orienting the weave of the 2 dimensional material containing conductive fibers in a manner to minimize electrical power consumption while achieving effective cure of the material. This discussion, including attached illustrations, discusses orienting woven conductive fibers in a machine direction, cross machine direction, or at an oblique angle. Also disclosed is orienting the direction of the conductive fibers in alternate conductive layers normal to the other layer.

The orientation of the conducting fibers becomes more important as the complexity of the shape of the composite material increases. Therefore there continues to be a need for a structurally sound, large and inexpensive composite. There is also a need for a composite that can be efficiently and quickly produced in molds or off line.

### SUMMARY OF INVENTION

The invention taught by this specification is a multi-layered composite material comprising one or more layers of woven or non woven fibrous material containing thermal responsive resin and one or more electrically conductive preform layers with circuits for resistive heating. The preform is formed into a shape by molding with specific fiber placement. The fibrous material may be pre-impregnated prior to placement in the mold. The electric circuit contained within the material is energized during the molding process. The mold may also be separately heated during molding.

It is an object of the invention to create a method of manufacture that allows thorough and controlled curing of molded resinous composite material.

It is another object of the invention to create a method of manufacture that allows quick and efficient turn-around on the large and relatively expensive parts used in producing molded composite materials.

It is another object of the invention to create a composite material of large and complex shape that can be structurally sound.

Other benefits of the invention will also become apparent to those skilled in the art and such advantages and benefits are included within the scope of this invention.

### BRIEF DESCRIPTION OF THE DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIGS. 1A and 1B illustrate cross section views of a laminate wherein one layer has electrical power supplied to electric circuits within the material being molded when the two mold sections are compressed together.

FIG. 2 illustrates a clam shell type mold for a boat hull within the mold contains electrical power cables for supplying power to the circuit paths within the molding material.

FIG. 3 is a top view of a boat hull mold material.

FIG. 4 is a cross section view of the boat hull mold material.

FIG. 5 is a detail of a cross sectional segment of the boat hull material illustrated in FIG. 4 and showing the multiple layers of materials, including two layers containing electrical circuitry.

FIG. 6 illustrates a top view of the boat hull mold material showing the two combined and over-laid circuit paths for resistive heating.

FIG. 7 illustrates a one of the circuit paths combined in FIG. 6.

FIG. 8 illustrate an alternate circuit path for one of possible multiple circuit layers contained within a multi-layered molded boat hull.

FIG. 9 illustrates an alternate circuit path patterns for possible use in combination with the circuit path illustrated in FIG. 8.

FIG. 10 illustrates an alternate electrical circuit pattern for a boat hull to be laid out in a flat substrate intended to be subsequently molded into a three dimensional complex shape.

FIG. 11 illustrates an alternate circuit pattern for possible use in combination with the circuit path illustrated in FIG. 10.

### DETAILED DESCRIPTION OF THE INVENTION

The above general description and the following detailed description are merely illustrative of the subject invention and additional modes, advantages and particulars of this invention will be readily suggested to those skilled in the art without departing from the spirit and scope of the invention. The teaching of this invention will be understood to be applicable for both the flat and three dimensional complex shapes. The preform composite materials may be of multiple material types and contain woven and un-woven fibrous material. The materials may be of multiple variety, size and number of layers. The preforms may be impregnated with thermally responsive resin prior to placement in a mold or be supplied dry. The invention includes material for placement within a laminate architecture to permit resistive heating or the composite laminate.

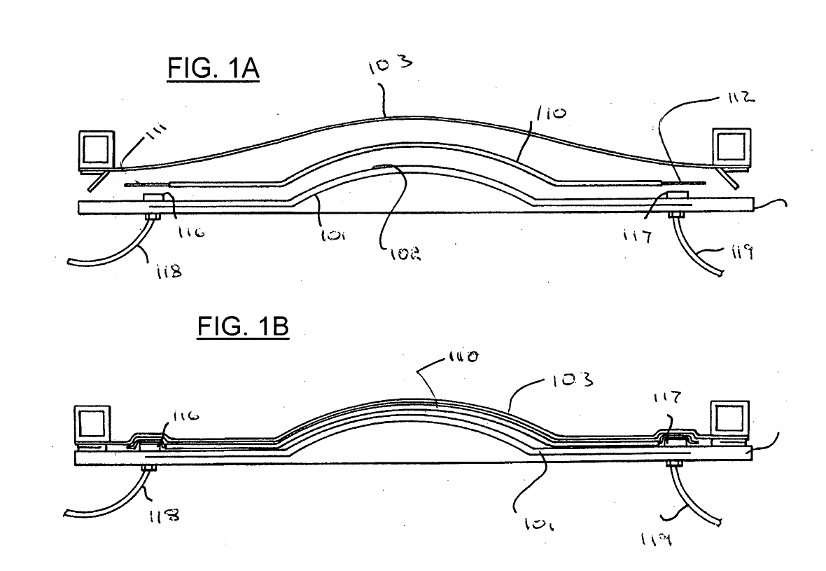

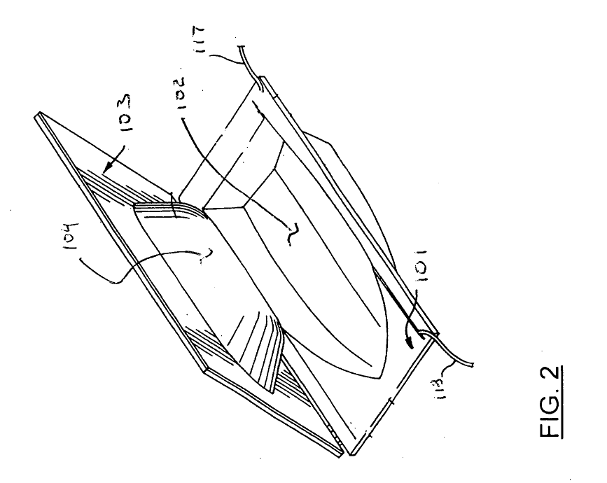

FIGS. 1A and 1B illustrates the basic elements and operation of the invention, specifically a mold portion 101 containing a mold surface 102 surface of the desired shape of the material. The mold also contains a second portion 103 which may be a fixed counter part to the shape of the first mold portion 101, thereby creating a male-female mold combination. Alternatively, the second portion 103 may be a flexible component suitable for creating a vacuum with the first mold portion. In either arrangement, the flexible and uncured material 110 is pressed into the shape of the surface 102 of the first mold 101 component as illustrated in FIG. 1B. Also illustrated is a method of providing electrical power to the mold material, containing electrically conductive circuit components 111 112. These components are placed in communication with an electric circuit comprised of electrical contacts, 116 117 and electrical power cables 118 119.

FIG. 2 illustrates an example of a complex, three-dimensional shaped mold 101 having a surface 102 forming a boat hull. In this example, the mold is a clam-shell type closed mold having a second component 103 forming a male component with a rigid surface 104 forming the interior of the boat hull surface. The mold also contains the electrical power cables 116 117 for communication with the electric circuit component of the mold material (not shown).

It will of course be appreciated that, although this specification speaks of molding of a boat hull shape, the invention is adaptable for and includes all shapes and structures for all applications.

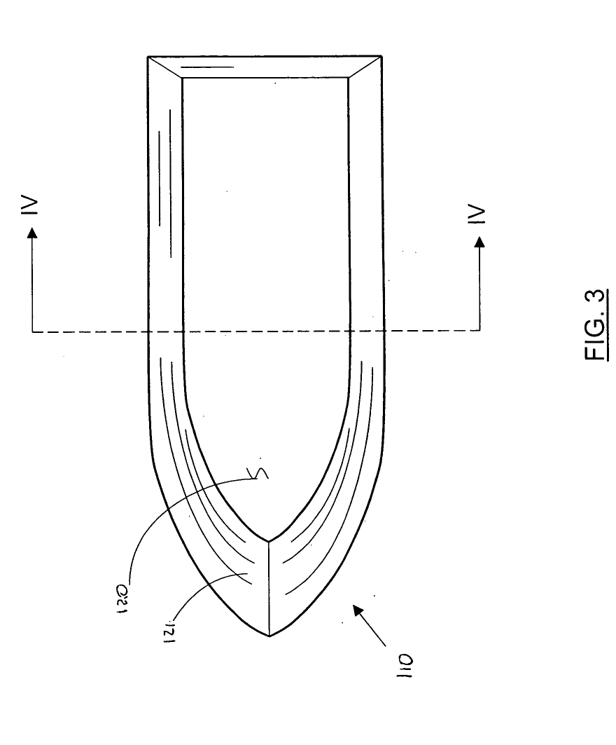

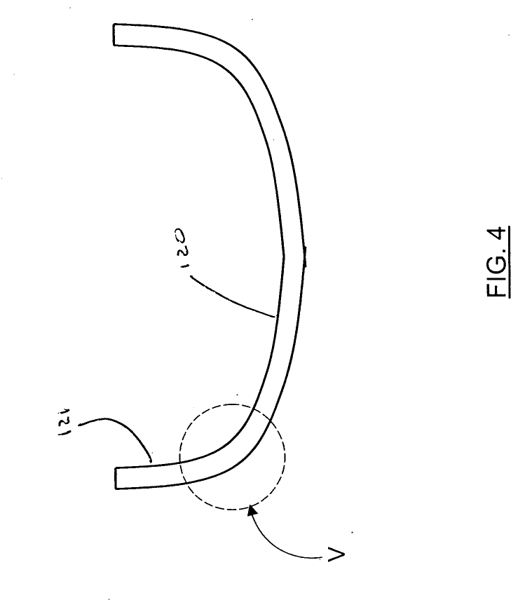

FIG. 3 illustrates a top view of the boat hull 110 showing the inner surface of the hull 120 and the inner side of the hull 121. FIG. 4 illustrates the cross section view of the hull, including the inner surface 120 and side 121.

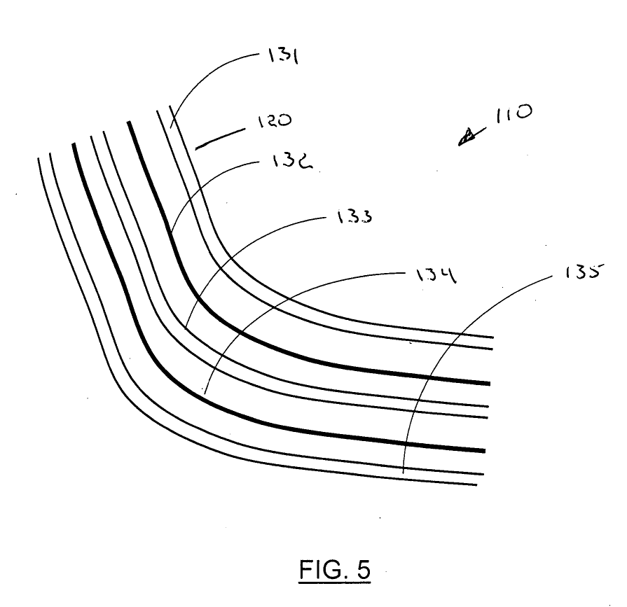

FIG. 5 illustrates a detail of the molded composite material 110 that, in this example, forms a boat hull. Material is comprised of multiple layers 131, 132, 133, 134 and 135, wherein the first inner layer 131, (forming the inner surface 120) middle layer 133, and outer layer 135 are contain fibers impregnated with resin. An example of the material forming these layers is fiber glass, but other suitable materials are well known in the industry and to persons skilled in the technology. The intervening layers 132 134 containing electrically conductive fibers or filaments such as wires, tapes or braids. Although metallic wire may be used, carbon or graphite fibers or braids are used in the preferred embodiment.

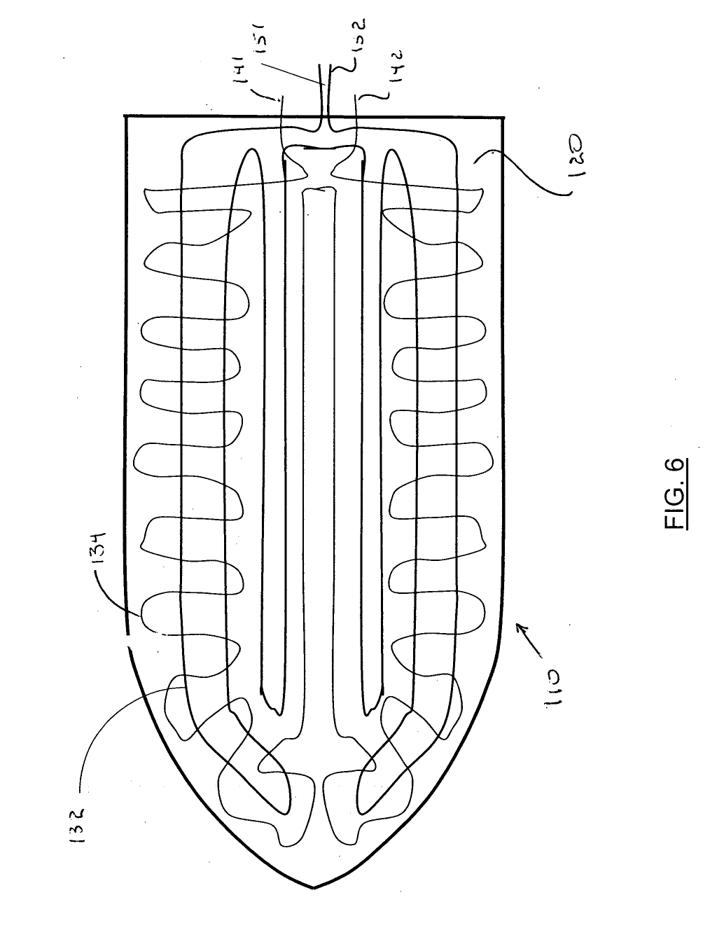

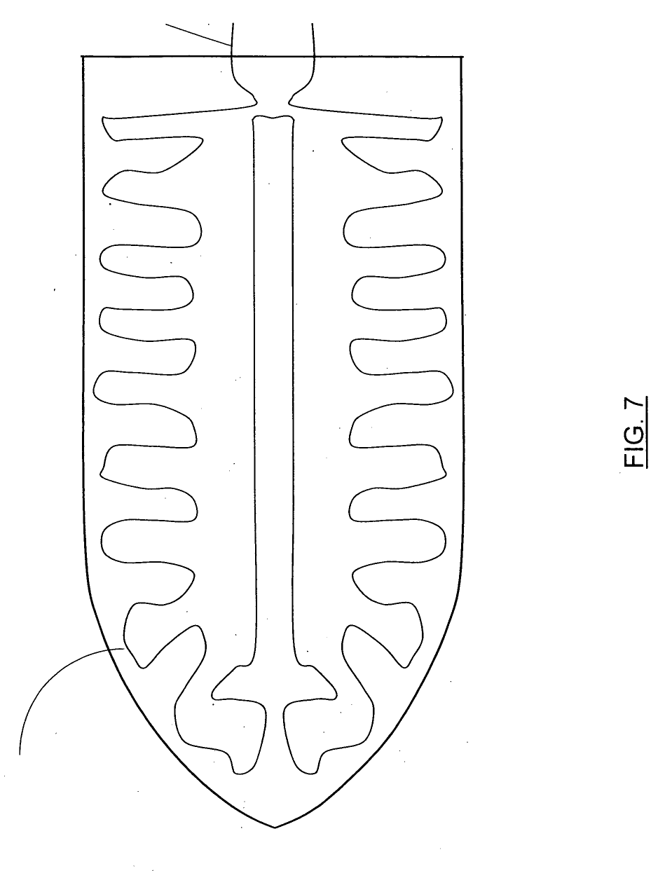

FIG. 6 illustrates the circuit path of the conductive fibers forming the two conductive layers 132 134 of the molded material 110. The layers are shown overlaying each other, although it will be understood that the conductive fibers layers will be electrically isolated from the other, preferably by the intervening layer 133 (not shown). Each circuit path has a pair of electrically conductive connectors 141-142 & 151-152 attachable to electrical power means, such as the cables 117 118 illustrated in FIGS. 1A, 1B and 2. It will be readily appreciated, after review FIG. 6 and other illustrations contained within this disclosure, that the one or more layers containing electrically conductive circuit paths are arranged in a pattern intended to generate and distribute resistive heating for the enhanced curing of the thermally responsive resin within the material. Such resin may, for example, impregnate the alternate layers 131, 133, 135 illustrated in FIG. 5. Of course, such resin may also be surrounding the fibers or braid forming the electrically conductive circuit path.

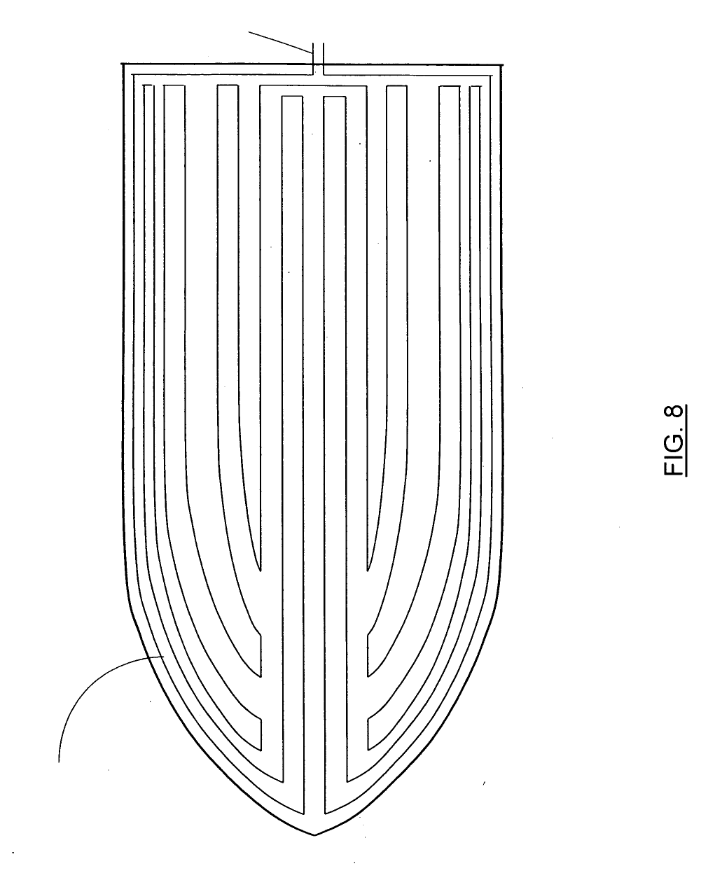

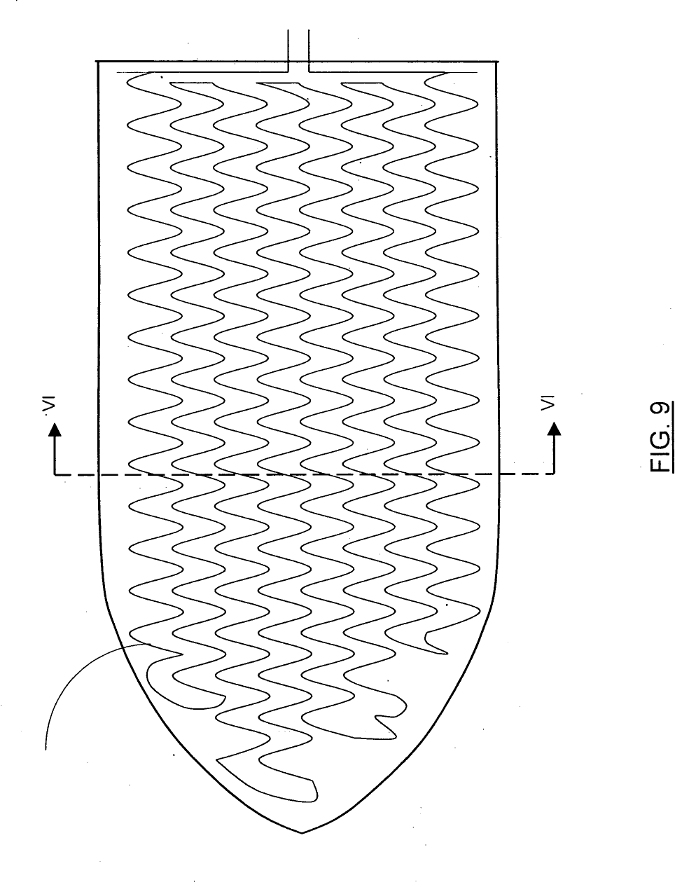

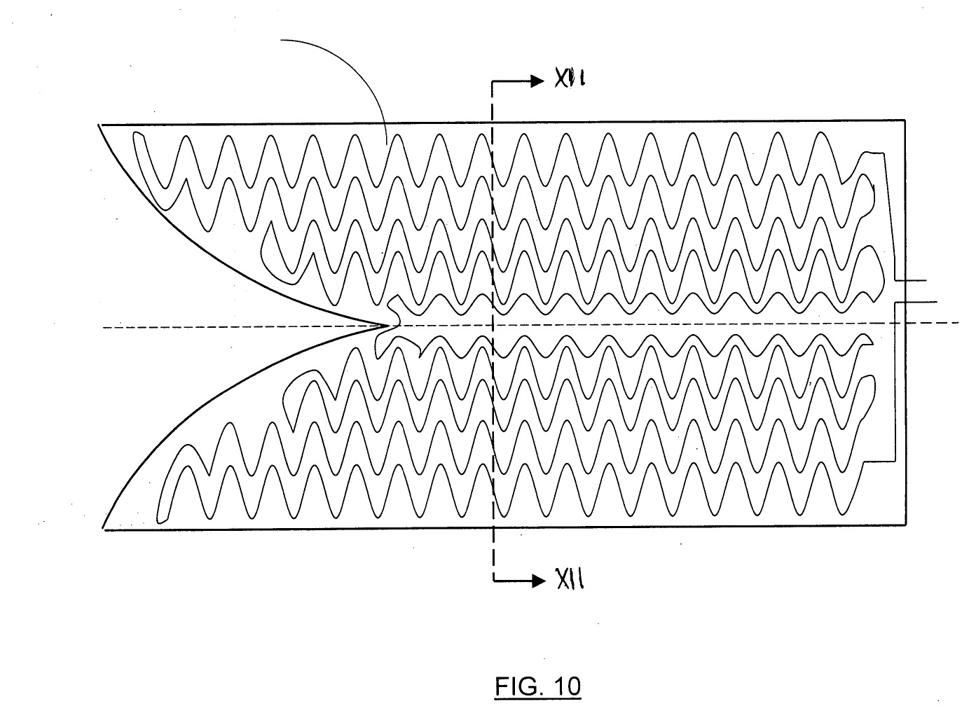

FIGS. 7, 8 and 9 separately illustrate the circuit paths contained within the molded material comprising the boat hull. It will be appreciated that the molded material may incorporate only one circuit, or a plurality of circuits. When multiple circuits are employed, each circuit can be placed between one or more resin impregnated material layers. Each circuit path may be of an individual pattern engineered for an intended dispersion of resistive heating within the composite layers, or of a repeating pattern or series of patterns.

The circuit paths may be laid down over flat layers of fiber or resin mats, followed by a successive layer or layers of fiber/resin mats. In an alternative embodiment, the conductive fiber or braid may be laid into a partially molded and uncured material layer of a three dimensional shape. The conductive fibers may be laid into pressed groves or channels within the uncured material surface in order that the intended pattern of the circuit path is maintained through the molding and curing stage.

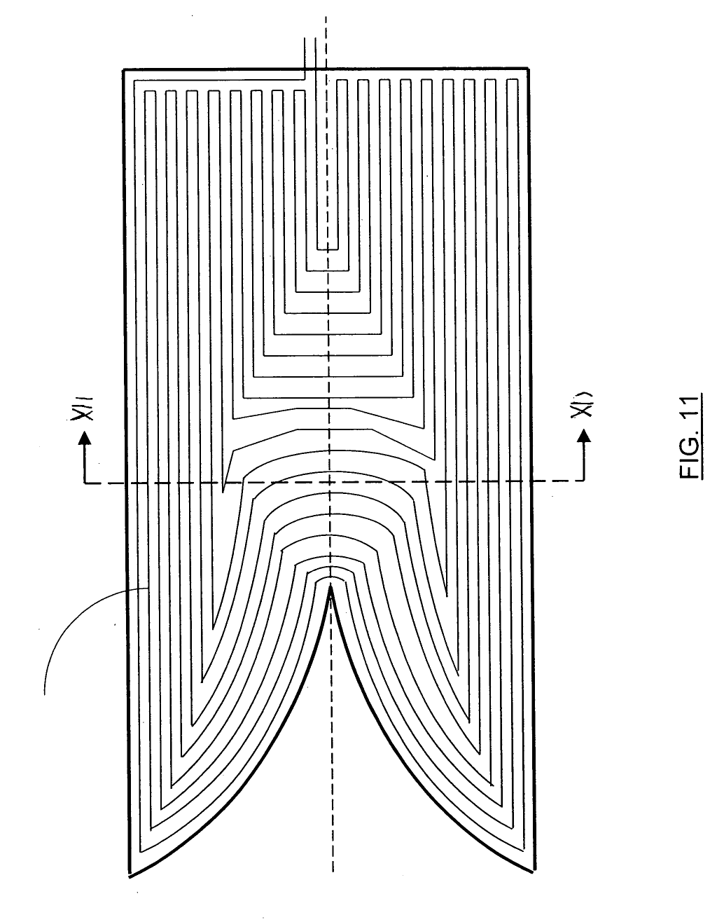

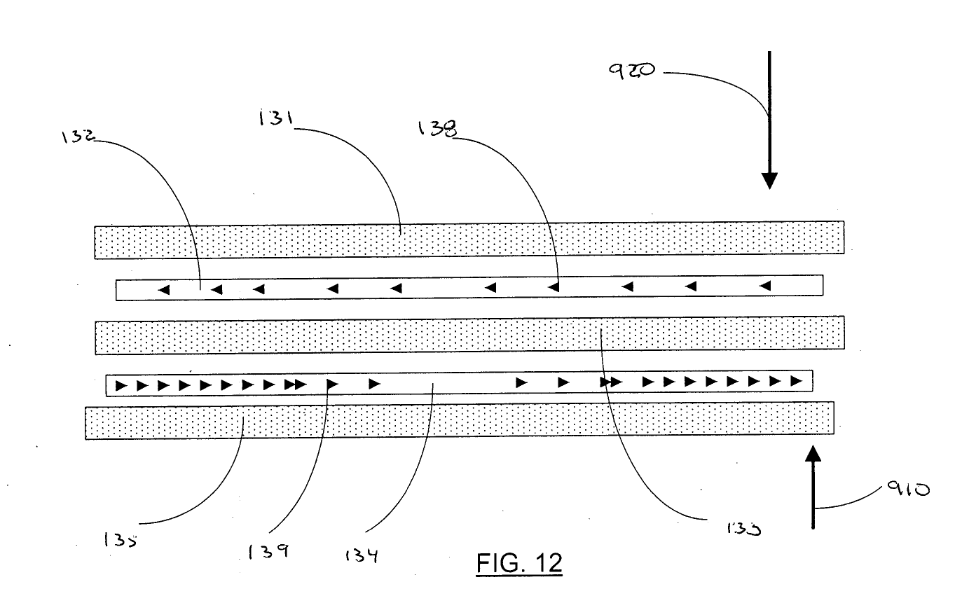

FIGS. 10 and 11 illustrate alternate and successive conductive fiber patterns laid upon flat material surfaces intended to be formed into a complex, three dimensional shape during molding. It will be appreciated that the conductive fibers can be most easily deployed in the intended pattern onto flat layers. In addition to laying of fibers into partially molded groves of uncured material discussed above, the fibers may also be held in place through curing by the tackiness of the uncured resin.

FIG. 12 illustrates a cross sectional view of the composite material comprising five layers 131, 132 133 134 135 wherein the conductive fibers 138 139 within the layers 132 134 comprise the circuit patterns illustrated in FIGS. 10 and 11.

This specification is to be construed as illustrative only and is for the purpose of teaching those skilled in the art the manner of carrying out the invention. It is to be understood that the forms of the invention herein shown and describe are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

1. An method of forming a reinforced composite comprising:
a. at least one first layer of fibrous material; and
b. at least one second layer of material containing electrically conducive fibers wherein the electrically conductive fibers are oriented in an intended pattern.

2. The method of claim 1 wherein the first layer contains a thermally responsive resin.

3. The invention of claim 1 wherein the pattern of electrically conductive fibers provides a substantially uniform distribution of conductive fibers in relation to the first material layer.

4. The invention of claim 1 wherein the electrically conductive fibers are oriented to transfer heat for a controllable cure of the laminate.

5. The invention of claim 4 wherein the resistive from the electrically conductive fibers is controlled for uniform cure of the laminate.
